(19) United States
(12) Patent Application Publication
(10) Pub. No.: US 2025/0107489 A1
(43) Pub. Date: Apr. 3, 2025

(54) SYSTEMS, METHODS, AND APPARATUSES FOR FOLDING AND ARTICULATING AN AGRICULTURAL HEAD

(71) Applicant: Deere & Company, Moline, IL (US)

(72) Inventors: DANIEL M. HEIM, PORT BYRON, IL (US); MATTHEW R. WHITE, GENESEO, IL (US)

(21) Appl. No.: 18/476,576

(22) Filed: Sep. 28, 2023

(51) Int. Cl. A01D 41/14

(52) U.S. Cl. CPC A01D 41/144

(57) ABSTRACT

Apparatuses, systems, and method for moving a wing frame of an agricultural head from a folded position to an unfolded position and to articulate the wing frame when in the unfolded configuration using a single actuator are disclosed. In some implementations, an agricultural head may include a center frame; a wing frame coupled to the center frame; and an intermediate portion disposed between the center frame and the wing frame. The intermediate portion may be pivotably connected to the center frame at a first pivot axis and pivotably connected to the wing frame at a second pivot axis. The first pivot axis may be offset from the second pivot axis.

### FIELD OF THE DISCLOSURE

The present disclosure relates generally to agricultural heads that include a folding capability as well as an articulation capability and, particularly, to agricultural heads that utilize an actuator that functions to both provide folding and articulation.

### BACKGROUND OF THE DISCLOSURE

Some agricultural heads, such as corn heads, include a folding capability in which a wing of the head is moveable between a folded configuration and an unfolded configuration. In the unfolded configuration, the wing is extended so that the head can perform a harvesting operation. In the folded configuration, the wing is retracted. By folding the wing, a lateral dimension of the head is reduced, allowing for transport of the head along a narrower path as opposed to a path needed to accommodate head with the wing in the unfolded configuration.

### SUMMARY OF THE DISCLOSURE

A first aspect of the present disclosure is directed to an agricultural head. The agricultural head may include a center frame, a wing frame coupled to the center, and an intermediate portion disposed between the center frame and the wing frame. The intermediate portion may be pivotably connected to the center frame at a first pivot axis and pivotably connected to the wing frame at a second pivot axis. The first pivot axis may be offset from the second pivot axis.

Another aspect of the present disclosure is directed to a method for operating an agricultural head moveable between a folded configuration and an unfolded configuration and articulatable in the unfolded configuration. The method may include actuating an actuator interconnecting a wing frame of the agricultural head and a center frame of the agricultural head by a first amount in a first direction to unfold the wing frame from a folded configuration to an unfolded configuration; pivoting the wing frame about a first pivot axis pivotably connecting an intermediate portion and the wing frame at a first location along the intermediate portion in a first rotational direction in response to actuating the actuator in the first direction to unfold the wing frame; actuating the actuator in the first direction by a second amount beyond the first amount; and pivoting the wing frame about a second pivot axis pivotably connecting the intermediate portion and the center frame at a second location along the intermediate portion offset from the first location in the first rotational direction in response to articulation of the actuator in the first direction by the second amount.

A further aspect of the present disclosure is directed to an agricultural system that may include an agricultural machine configured to move along a surface and an agricultural head connected to the agricultural machine and configured to harvest crop as the agricultural head is moved along the surface by the agricultural machine. The agricultural head may include a center frame; a wing frame coupled to and disposed laterally adjacent to the center; and an intermediate portion disposed between the center frame and the wing frame. The intermediate portion may be pivotably connected to the center frame at a first rotational axis and pivotably connected to the wing frame at a second rotational axis. The first rotational axis may be positioned at a first location on the center frame and the second rotational axis positioned at a second location along the wing frame. The first location may be offset from the second location.

The various aspects of the present disclosure may include one or more of the following features. A vertical component of the first location may be less than a vertical component of the second location. An actuator may interconnect the center frame and the wing frame. The actuator may be configured both to rotate the wing frame relative to the center frame about the second pivot axis a first rotational amount between a folded configuration and an unfolded configuration and to articulate the wing frame a second rotational amount beyond the first rotational amount relative to the center frame about the first pivot axis between the unfolded configuration and a fully articulated configuration. The wing frame may be pivotable about the first pivot axis, in response to actuation of the actuator, between the unfolded configuration and the fully articulated configuration. A first pivot shaft may define the first pivot axis. A second pivot shaft may define the second pivot axis. The second pivot shaft may be fixed relative to the center frame when the wing frame is pivoted at least partially between the folded configuration and unfolded configuration, and the second pivot shaft may be movable relative to the center frame when the wing frame is pivoted between the unfolded configuration and the fully articulated configuration. A linkage may include a first link pivotably attached to the center frame, and a second link pivotably attached to the wing frame. The first link and the second link may be pivotably attached to each other. The actuator may be pivotably attached to the center frame at a first end and pivotably connected to the linkage at a location where the first link and the second link are pivotably attached to each other. An actuator, interconnecting the center frame and the wing frame, may be configured to pivot the wing frame relative to the center frame about one of the first pivot axis and the second pivot axis. The actuator may be a linear actuator. The linear actuator may be a hydraulic linear actuator.

Additionally, the various aspects may include one or more of the following features. Pivoting the wing frame about the second pivot axis in response to articulation of the actuator by the second amount may include pivoting the wing frame between the unfolded configuration and a fully articulated configuration. Pivoting the wing frame about a first pivot axis pivotably connecting a first end of an intermediate portion and the wing frame in a first rotational direction in response to actuating the actuator in the first direction to unfold the wing frame may include pivoting the wing frame about the first pivot axis a first rotational amount in the first rotational direction. a location of the first pivot axis relative to the center frame may be fixed such that the intermediate portion is prevented from rotating relative to the center frame about the second pivot axis when the when the wing frame is pivoted about the first pivot axis in the first rotational direction in response to actuation of the actuator in the first direction. Pivoting the wing frame about a second pivot axis pivotably connecting a second end of the intermediate portion, opposite the first end, and the center frame in the first rotational direction in response to articulation of the actuator in the first direction by the second amount may include releasing the first pivot axis relative to the center frame to cause the intermediate portion to pivot about the second pivot axis relative to the center frame. The first wing frame may pivot about the second pivot axis by a first rotational amount between the fully articulated configuration and the unfolded configuration in response to actuation of the actuator by a first amount in a second direction, opposite the first direction. The second pivot axis may be fixed relative to the center frame when the wing frame is pivoted at least partially between the folded configuration and unfolded configuration, and the second pivot axis may be movable relative to the center frame when the wing frame is pivoted between the unfolded configuration and the fully articulated configuration.

Other features and aspects will become apparent by consideration of the detailed description and accompanying drawings.

### BRIEF DESCRIPTION OF THE DRAWINGS

The detailed description of the drawings refers to the accompanying figures in which:

FIG. 1 a perspective view of an example combine harvester, according to some implementations of the present disclosure.

FIG. 2 is a diagrammatic view of an example agricultural head, according to some implementations of the present disclosure.

FIG. 3 is another diagrammatic view of the agricultural head of FIG. 2 with the wing frames in a raised orientation.

FIG. 4 is another diagrammatic view of the agricultural head of FIG. 2 with the wing frames in a lowered orientation.

FIG. 5 is a partial diagrammatic view of the example agricultural head of FIG. 2 with the wing frame in an unfolded configuration.

FIG. 6 is another partial diagrammatic view of the example agricultural head of FIG. 2 with the wing frame in a folded configuration.

FIG. 7 is a detailed view of an interface between the center frame and one of the wing frames, according to some implementations of the present disclosure.

FIG. 8 is a flowchart of an example method of operating an agricultural head between a folded configuration and an unfolded configuration and articulating the agricultural head in the unfolded configuration, according to some implementations of the present disclosure.

FIG. 9 is a partial diagrammatic view of another example agricultural head that includes a center frame and a wing frame in the folded configuration, according to some implementations of the present disclosure.

FIG. 10 is a partial diagrammatic view of the agricultural head of FIG. 9 with an intermediate portion released from a fixed position relative to the center frame.

FIG. 11 is a partial diagrammatic view of the agricultural head of FIG. 9 with the wing frame in the unfolded configuration.

FIG. 12 is a partial diagrammatic view of the agricultural head of FIG. 9 with the wing frame in a fully articulated configuration.

FIG. 13 is a flowchart of another example method of operating an agricultural head between a folded configuration and an unfolded configuration and articulating the agricultural head in the unfolded configuration, according to some implementations of the present disclosure.

FIG. 14 is a schematic view of an example control system, according to some implementations of the present disclosure.

FIG. 15 is a block diagram illustrating an example computer system used to provide computational functionalities associated with described algorithms, methods, functions, processes, flows, and procedures as described in the present disclosure, according to some implementations of the present disclosure.

### DETAILED DESCRIPTION

For the purposes of promoting an understanding of the principles of the present disclosure, reference will now be made to the implementations illustrated in the drawings, and specific language will be used to describe the same. It will nevertheless be understood that no limitation of the scope of the disclosure is intended. Any alterations and further modifications to the described devices, systems, or methods and any further application of the principles of the present disclosure are fully contemplated as would normally occur to one skilled in the art to which the disclosure relates. In particular, it is fully contemplated that the features, components, and/or steps described with respect to one implementation may be combined with the features, components, and/or steps described with respect to other implementations of the present disclosure.

The present disclosure is directed to agricultural heads that include both a folding capability as well as the ability to articulate during a harvesting operation. A single actuator provides the ability to both fold a wing of the head as well as to provide the articulation movement. Further, folding is accomplished relative to a first pivot axis at an interface between the wing and a center frame of the head, while articulation is accomplished relative to a second pivot axis, offset from the first pivot axis, at the interface between the wing and the center frame of the head.

Words of orientation, such as “up,” “down,” “top,” “bottom,” “above,” “below,” “leading,” “trailing,” “front,” “back,” “forward,” and “rearward” are used in the context of the illustrated examples as would be understood by one skilled in the art and are not intended to be limiting to the disclosure. For example, for a particular type of vehicle in a conventional configuration and orientation, one skilled in the art would understand these terms as the terms apply to the particular vehicle.

For example, the term “forward” (and the like) corresponds to a forward direction of travel of a head or combine harvester, such as during a harvesting operation. Likewise, the term “rearward” (and the like) corresponds to a direction opposite the forward direction of travel. In this regard, for example, a “forward facing” feature on a head may generally face in the direction that the head travels during normal operation, while a “rearward facing” feature may generally face opposite that direction.

Also as used herein, with respect to a head (or components thereof), unless otherwise defined or limited, the term “leading” (and the like) indicates a direction of travel of the head during normal operation (e.g., the forward direction of travel of a harvester vehicle carrying a head). Similarly, the term “trailing” (and the like) indicates a direction that is opposite the leading direction. In this regard, for example, a “leading” edge of a head may be generally disposed at the front of the head, with respect to the direction travel of the head during normal operation (e.g., as carried by a combine harvester). Likewise, a “trailing” edge of a head may be generally disposed at the back of the head opposite the leading edge, with respect to the direction of travel of the head during normal operation.

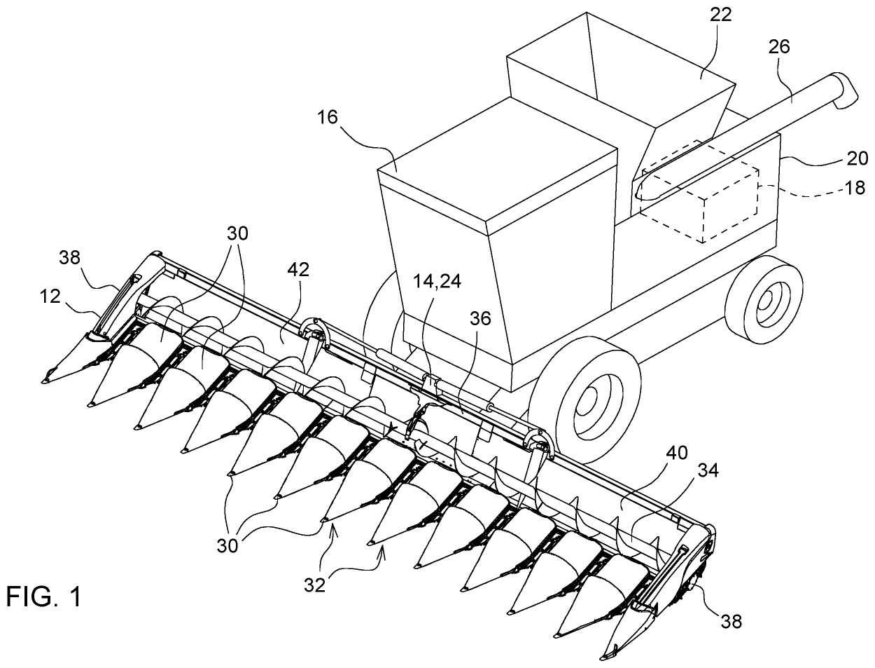

FIG. 1 is a perspective view of an example combine harvester 10 with a head 12 attached thereto at a forward end 14. The combine harvester 10 includes an operator cab 16, a power source 18 disposed within a body 20 of the combine harvester 10, a clean grain bin 22, a feeder house 24 to which the head 12 attaches, an unloader 26, and a plurality of ground engaging components 24 (such as wheels or tracks) that transport the combine harvester 10 along the ground.

The head 12 is in the form of a corn head that includes a plurality of row units 28 arranged laterally along the head 12. The row units 28 are used to engage crop, sever the crop from ground, and remove corn cars from corn stalks. The head 12 also includes crop dividers 30 located between laterally adjacent row units 28 that direct corn stalks into slots 32 defined by of the row units 28. The head 12 also includes an auger 34 downstream of the row units 28. The auger 34 operates to direct corn ears to a central location along the head 12 from where the corn cars are directed into the combine harvester 10, such as for further processing.

Additionally, the head 10 includes a includes a center frame 36 flanked by wing frames 38 at opposing sides 40 and 42 of the center frame 34. A portion of the row units 28 and the associated crop dividers 30 are coupled to the center frame 36, and a plurality of the row units 28 and the associated crop dividers 30 are coupled to the wing frames 38. The wing frames 38 are pivotable relative to the center frame 34 between a folded or road configuration and an unfolded or field configuration.

The head 10 also includes actuators 42. One of the actuators 42 extends between the center frame 34 and one of the wings 36, and a second actuator 42 extends between the center frame 34 and the other wing 34. In some implementations, the actuators 42 are hydraulic linear actuators. In other implementations, the actuators 42 can be other types of actuators, such as electric actuators (e.g., electric linear actuators). Each of the actuators 42 is operable to perform a dual function with respect to the associated wing 36. Particularly, each actuator 42 is operable to move the associated wing 36 between a folded configuration and an unfolded configuration. Additionally, each actuator 42 is operable to provide articulation of the associated wing 36 when the wing 36 is in the unfolded configuration. More particularly, the actuator 42 is operable to articulate the associated wing 36 during a harvesting operation to allow the wing 36 to conform to topographical changes of the ground. In the unfolded configuration, the actuators 42 are operable to pivot the respective wing 34 a selected angular range.

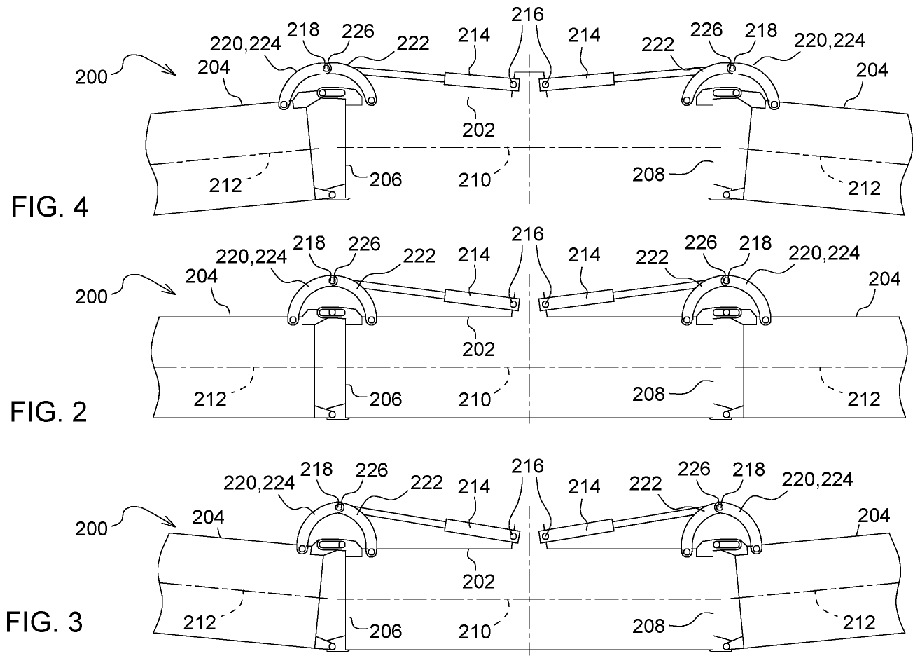

FIG. 2 is a diagrammatic view of an example agricultural head 200 within the scope of the present disclosure. Similar to the head 10, the head 200 includes a central frame 202 and wing frames 204 disposed on opposing lateral sides 206, 208 of the center frame 202. As shown, the wings frames 204 are aligned with the center frame 202. That is, a lateral axis 210 of the center frame 202 is aligned with lateral axis 212 of the wing frames 204. As shown in the example of FIG. 2, the wing frames 204 are positioned at a location along an articulation range. The articulation range is an angular range beyond an angular range between the folded configuration and the unfolded configuration that allows the wing frames 204 to conform to a shape of the ground over which the head 200 is being transported, such as during a harvesting operation. In some implementations, the articulation range is an angular range defined between a first position of the wing frames 204 in which the wing frames 204 are in a raised orientation (e.g., as shown in FIG. 3) and a second position of the wing frames in which the wing frames are in a lowered orientation (e.g., as shown in FIG. 4).

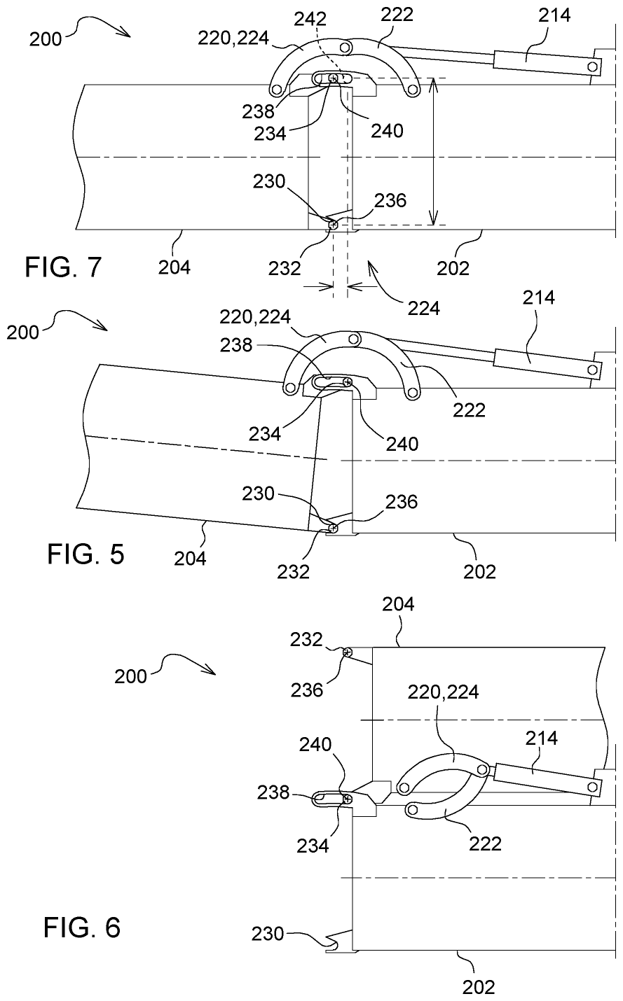

FIGS. 5 and 6 are partial views of the header 200. In FIG. 5, the wing frame 204 is in the unfolded configuration. As can be seen in the illustrated example, the wing frame 204 has a raised orientation relative to the center frame 202. In FIG. 6, the wing frame 204 is in the folded configuration in which the wing frame 204 overlays or staked onto the center frame 202.

Returning to FIG. 2, the head 200 also includes actuators 214 that interconnect the center frame 202 to the wing frames 204. Particularly, one of the actuators 214 interconnects the wing frame 202 and one of the wing frames 204, while the other actuator 214 interconnects the center frame 202 and the other wing frame 204. The actuators 214 may be similar to the actuators 42. For example, in the illustrated example, the actuators 214 are linear actuators, such as hydraulic linear actuators. First ends 216 of the actuators 214 is connected to the center frame 202. Second ends 218 of the actuators 214 are connected to linkages 220. Each linkage 220 are connected to one of the wing frames 204 and the center frame 202. Each of the linkages 220 includes a first link 222 pivotably connected to the center frame 202 and a second link 224 pivotably connected to the wing frame 204. The links 222 and 224 are also pivotably connected to each other at pivot pin 226.

FIG. 7 is a detail view of an interface 228 between the center frame 202 and one of the wing frames 204. At the interface 228, the center frame 202 includes a receptacle 230, and the wing frame 204 includes a pivot shaft 232. The pivot shaft 232 is releasably received into the receptacle 230. The receptacle 230 and pivot shaft 232 are positioned at a location lower on the head 200 than a pivot shaft 234, discussed in more detail below. Thus, locations of the receptacle 230 and pivot shaft 232 have a vertical component that is less than a vertical component of a pivot shaft 234.

The receptacle 230 receives the pivot shaft 232, and the pivot shaft 232 defines a pivot axis 236 that extends longitudinally along the pivot shaft 232. When received into the receptacle 230, the wing frame 204 is pivotable about the pivot axis 236.

The pivot shaft 234 is fixedly attached to the wing frame 204 and is received in and slidable within a slot 238 formed on the center frame 202. The pivot shaft 234 is positioned at a more raised location on the wing frame 204 than the pivot shaft 232. Thus, the pivot shaft 232 and the pivot shaft 234 are offset from each other. In some implementations, the offset includes both a vertical offset and a lateral offset. In other implementations, the offset may be different. For example, in some instances, the offset may be entirely a vertical offset. However, the scope is not so limited, and the offset between the pivot shaft 232 and the pivot shaft 234 may vary depending on a configuration of the head 200.

The pivot shaft 234 defines a pivot axis 240 that extends longitudinally along the pivot shaft 234. The slot 238 extends generally laterally and, in some instances, has a curved shape. The pivot shaft 234 is retained within the slot 238. In some implementations, the pivot shaft 234 can be releasably locked at one or more locations along the slot 238. For example, in some instances, the pivot shaft 234 is releasably lockable at inboard location 242. At location 242, the wing frame 204 pivots about a pivot axis 240.

Operation of the header 200 is now described. With the wing frame 204 in the folded configuration (for example, as shown in FIG. 6), the pivot shaft 234 is at an inboard location within the slot 238. In the illustrated example, the pivot shaft 234 is at the innermost inboard position within the slot 238. In some instances, the pivot shaft 234 is secured or locked at this position in order to facilitate unfolding of the wing frame 204.

To unfold the wing frame 204, the actuator 214 is extended a first amount to cause the wing frame 204 pivot about the pivot axis 240 a selected amount, rotating the wing frame 204 from the folded configuration to the unfolded configuration, as shown in FIGS. 3 and 5. In some implementations, as the wing frame 204 reaches the unfolded configuration, the pivot shaft 232 is received into the receptacle 230. Further, in some implementations, the pivot shaft 232 is releasably locked into the receptacle 230 to prevent removal of the pivot shaft 232 therefrom during articulation of the wing frame 204, described below.

With the wing frame 204 in the unfolded configuration, the pivot shaft 234 is released from the inboard location within the slot 238, thereby allowing the pivot shaft 234 to slide in the slot 238 as the wing frame 204 is articulated, i.e., pivoted about the pivot axis 236, such as during a harvesting operation. Further extension of the actuator 214 beyond the first amount causes the wing frame to articulate, such as to accommodate to terrain during a harvesting operation. Articulation of the wing frame 204 involves rotation of the wing frame 204 about the pivot axis 236. Articulation involves rotation of the wing frame 204 about a selected angular range about the pivot axis 236. As explained above, in some implementations, the angular range extends between a location in which the wing frame 204 is a raised orientation (as shown in FIG. 3) and location in which the wing frame 204 is a lowered orientation (as shown in FIG. 4). The actuator 214 is further extendable a second amount, beyond the first amount, to cause the wing frame 204 to rotate about the pivot axis 236 through this angular range. Further, the actuator 214 can extend and retract to move the wing frame 204 through the angular range, such as to cause the wing frame 204 to follow contour of the ground over which the head 200 is being transported.

In returning the wing frame 204 to the folded position, the actuator 214 is retracted, rotating the wing frame 204 about the pivot axis 236 until the pivot shaft 234 reaches the inboard location within the slot 238. In this example, the selected location within the slot 238 is the innermost inboard location within the slot 238, such as location 242 shown in FIG. 7. With the pivot axis 236 at the selected location within the slot 238, in some implementations, the pivot axis 236 is releasably locked at that location, and the pivot axis 232 is unlocked from the receptacle 230. The wing frame 204 is, thus, placed in the unfolded configuration. The actuator 214 is further retracted the first amount to move the wing frame 204 from the unfolded configuration to the folded configuration. Retraction of actuator 214 in this way rotates the wing frame 204 a selected amount about the pivot axis 240, removing the pivot axis 236 from the receptacle 230.

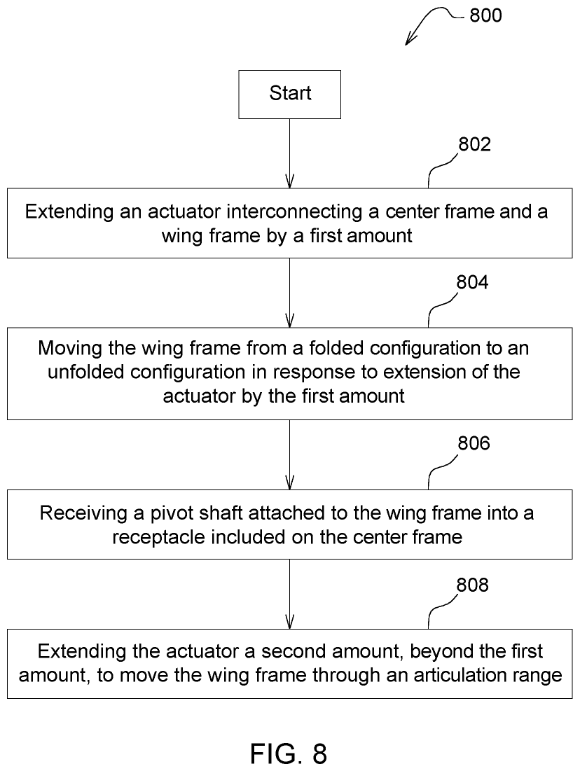

FIG. 8 is a flowchart of an example method 800 of operating an agricultural head between a folded configuration and an unfolded configuration and articulating the agricultural head in the unfolded configuration. At 802, an actuator (which may be similar to actuator 214) interconnecting a center frame (which may be similar to the center frame 202) of the agricultural head (which may be similar to head 200) and a wing frame (which may be similar to wing frame 204) of the head is extended a first amount. In response, the wing frame is moved, such as via rotation about a first pivot axis, from a folded configuration to an unfolded configuration, as indicated at 804. At 806, a pivot shaft attached to the wing frame is received into a receptacle of the center frame when the wing frame reaches the unfolded configuration. Although the pivot shaft is described as being included with the wing frame and the receptacle included with the center frame, in other implementations, the pivot shaft may be included on the center frame, and the receptacle may be included on the wing frame. At 808, the actuator is further extended a second amount, beyond the first amount, to move the wing frame through an articulation range. In some implementations, movement of the wing frame in response to extension of the actuator by the second amount involves rotation of the wing frame about a second pivot axis. In some instances, the wing frame is rotated about the second pivot axis along an angular range (corresponding to the articulation range) in response to extension of the actuator by the second amount. The actuator may be extended or retracted to cause the wing frame to be lowered or raised, respectively, as the wing is rotated within the angular range.

Various features of method 800 may be rearranged, added, or removed and still be within the scope of the present disclosure. For example, the method 800 may include locking the pivot shaft into the receptacle. Additionally, the method 800 may include retracting the actuator to move the wing frame to the unfolded configuration and further retracting the actuator to move the wing frame from the unfolded configuration to the folded configuration. Further, moving the wing frame through an articulation range in response to extension of the actuator by the second amount may also include moving a second pivot shaft included on the wing frame through a slot included on the center frame. The method 800 may also include locking the second pivot shaft at a location in the slot when, for example, moving the wing frame between the folded configuration an unloaded configuration.

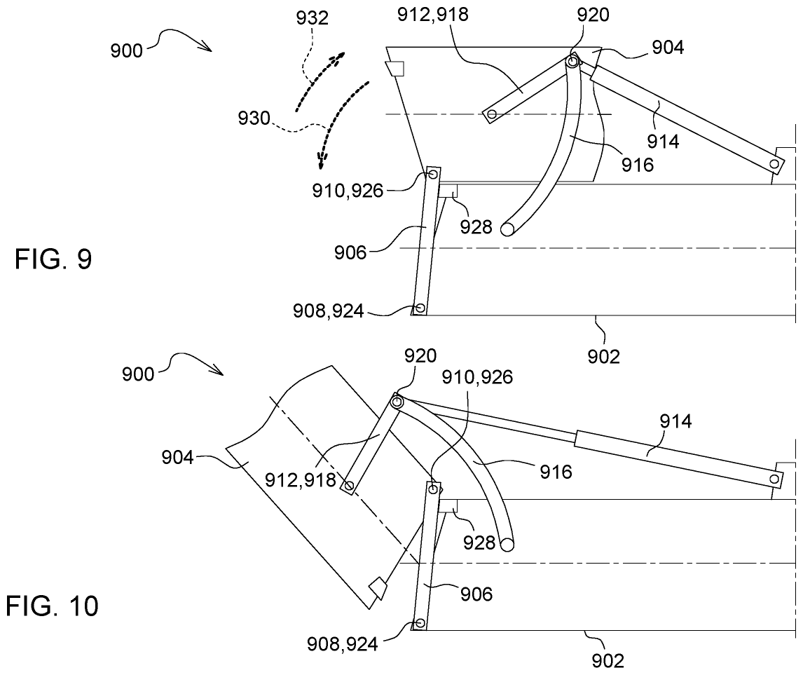

FIG. 9 is a partial diagrammatic view of another example agricultural head 900 that includes a center frame 902 and a wing frame 904. Although a single wing frame 904 is shown, the agricultural head 900 may also include a second wing frame located adjacent to the center frame 902 on a side opposite the wing frame 904. As shown, the wing frame 904 is in the folded configuration. The wing frame 904 is connected to the center frame 902 with an intermediate portion 906. The intermediate portion 906 is pivotably connected to the center frame 902 along a first pivot axis 908 and pivotably connected to the wing frame 904 at a second pivot axis 910. The first pivot axis 908 and the second pivot axis 910 are offset from each other along a length of the intermediate portion 906. As shown, the first pivot axis 908 has a position that is lower than a position of the second pivot axis 910. For example, a vertical component of the location of the first pivot axis 908 is less than a vertical component of the location of the second pivot axis 910. In some implementations, the first pivot axis 908 remains above the second pivot axis 910 throughout movement of the wing frame 904 relative to the center frame 902, including folding or unfolding of the wing frame 904 relative to the center frame 902 as well as articulation of the wing frame 904 over the articulation range, as described in greater detail below. The wing frame 904 and the center frame 902 are also connected via a linkage 912, and an actuator 914 is pivotably connected to the linkage 912. The linkage 912 includes a first link 916 pivotably connected to the center frame 902 and a second link 918 pivotably connected to the wing frame 904. The links 916 and 918 are pivotably connected to each other at a location 920. A first end 922 of the actuator 914 pivotably connected to the linkage 912 at the location 920. The actuator 914 may be similar to the actuator 214. Thus, in some implementations, the actuator 914 may be a linear actuator, such as a hydraulic linear actuator. A first pivot shaft 924 defines the first pivot axis 908, and a second pivot shaft 926 defines the second pivot axis 910. In some implementations, the first pivot shaft 924 couples the intermediate portion 906 to the wing frame 902, and the second pivot shaft 926 couples the intermediate portion 906 to the wing frame 904.

In the folded configuration, as shown in FIG. 9, a location of the second pivot axis 910 (and, hence, the first pivot shaft 924) relative to the center frame 902 is fixed during at least a portion of the movement of the wing frame 904 relative to the center frame 902 as the wing frame 904 is unfolded, in some implementations. For example, the second pivot shaft 910 (and, hence, the end of the intermediate portion 906 through which the second pivot axis 910 passes) is fixed, such as being locked into position (e.g., with the use of a lock 928), as the wing frame 904 is rotated from the folded configuration to the unfolded configuration. The lock 928 may engage the second pivot shaft 926 or a part of the intermediate portion 906 to prevent the intermediate portion 906 and, consequently, the second pivot shaft 926 from pivoting about the first pivot axis 908 relative to the center frame 902.

In some implementations, the location of the second pivot axis 910 relative to the center frame 902 may be released when the wing frame 904 reaches the unfolded configuration or at some position of the wing frame 902 prior to reaching the unfolded configuration. Securing the second pivot axis 910 into position in this way avoids the risk of the intermediate portion 906 pivoting about the first pivot axis 908 as the center of gravity of the wing frame 904 moves during unfolding. This avoided movement of the wing frame 904 can be sudden, which could cause damage to the agricultural head 900. Therefore, by securing the second pivot axis 910 in this way reduces or avoids the risk of damage to the agricultural head 900 as the wing frame 904 is unfolded.

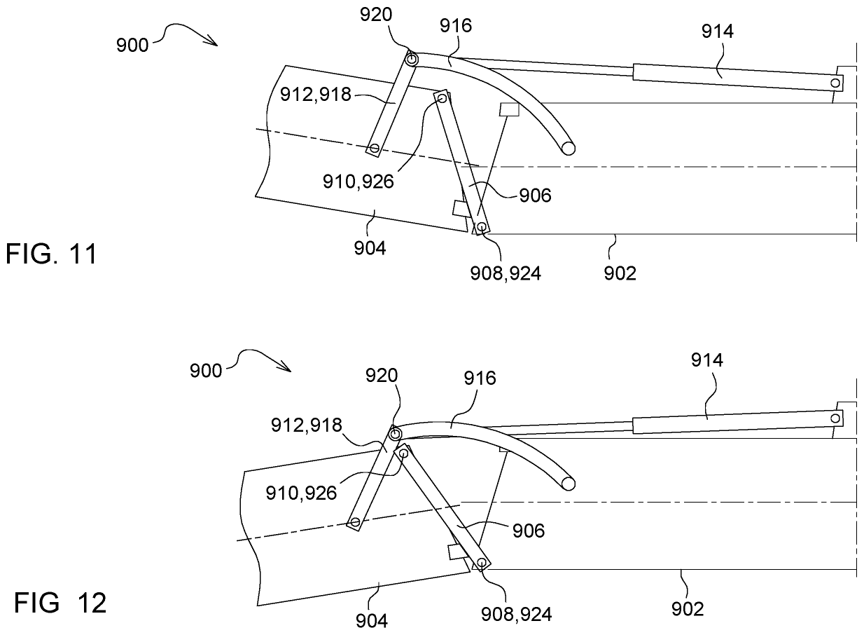

In operation, the actuator 914 is extended by a first amount, causing the wing frame 904 to pivot about the second pivot axis 910 in the direction of arrow 930 by a first rotational amount (e.g., by a first angular amount). Extension of the actuator 914 by the first amount rotates the wing frame 904 by the first rotational amount into the unfolded configuration, as shown in FIG. 11. However, in some implementations, as the wing frame 904 is moved to the unfolded configuration, the wing frame 904 reaches a position at which the intermediate portion 906 is released by the lock 928, as shown in FIG. 10. With the intermediate portion 906 released, further extension of the actuator 914 allows the wing frame 904 to rotate relative to the center frame 902 about the first pivot axis 908 as well as about the second pivot axis 910 as the wing frame 904 moves towards the unfolded configuration.

In the unfolded configuration, in some implementations, the wing frame 904 has a raised orientation. Further extension of the actuator 914 by a second amount, beyond the first amount, moves the wing frame 904 through an articulation range. For example, extension of the actuator 914 by the second amount causes the wing frame 904 to rotate about the second pivot axis 910 a second rotational amount (e.g., by a second angular amount) beyond the first rotational amount. The second angular amount is an angular range between the unfolded configuration of the wing frame 904 and a fully articulated configuration of the wing frame 904. FIG. 12 shows the agricultural head 900 with the wing frame 904 fully articulated at the end of the articulation range. Thus, FIG. 12 shows the wing frame 904 in the fully articulated configuration. In the fully articulated configuration, the wing frame 904 has a lowered orientation. As explained earlier, operation of the actuator 914 to move the wing frame 904 over the articulation range allows the wing frame 904, and the head 900 generally, to follow a contour of the ground as the head 900 is moved over the ground (such as during a harvesting operation). The actuator 914 is actuated, i.e., extended and retracted, to move the wing frame 904 over the articulation range. As the actuator 914 is actuated to move the wing frame 904 over the articulation range, the wing frame 904 is pivoted relative to the center frame 902 along the first pivot axis 908.

The agricultural head 900 may be returned to the folded condition by retracting the actuator 914 to place the wing frame 904 into the unfolded configuration, as shown in FIG. 11. The actuator 914 is retracted by the first amount to pivot the wing frame 904 to the folded configuration. As the actuator 914 retracts and the wing frame 904 rotates about the first pivot axis 908. As the wing frame 904 rotates about the first pivot axis 908, the wing frame 904 reaches a position where the intermediate portion 906 also rotates about the first pivot axis 908. Rotation of the intermediate portion 906 continues until the second pivot axis 910 reaches a selected position, such as when the intermediate portion 906, the wing frame 904, or both engage the center frame 902. When the selected position is reached, the intermediate portion 906 may be locked into the selected position. The actuator 914 further retracts, causing the wing frame to rotate about the second pivot axis 910 in the direction of arrow 932, opposite the direction of arrow 930, until the wing frame reaches the folded configuration, as shown in FIG. 9.

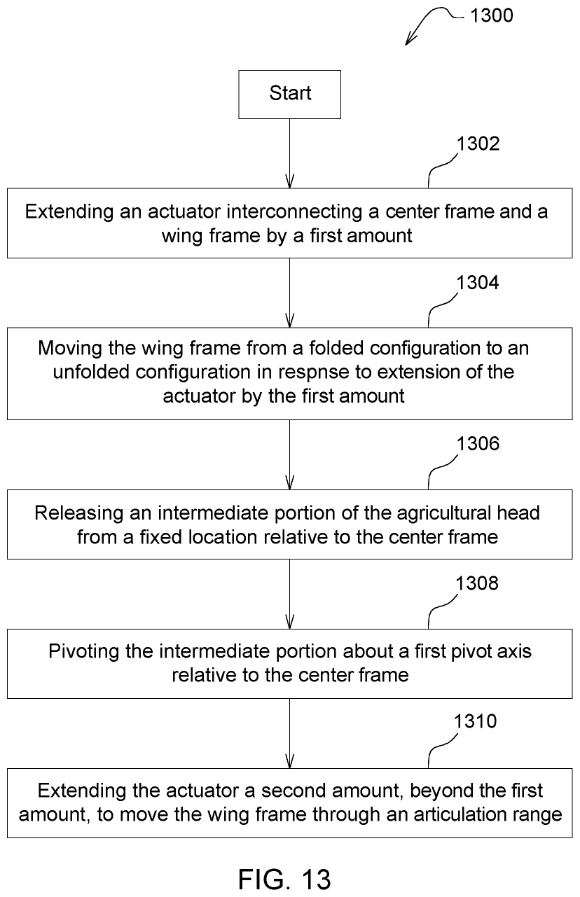

FIG. 13 is a flowchart of an example method 1300 of operating an agricultural head, such as head 900, during folding and unfolding the agricultural head and articulating the agricultural head in the unfolded configuration. The head includes a center frame (such as center frame 902), a wing frame (such as wing frame 904), and an intermediate portion (which may be similar to intermediate portion 906). The intermediate portion interconnects the center frame and the wing frame. The intermediate portion is pivotably connected to the center frame at a first pivot axis (such as pivot axis 908), and the intermediate portion is pivotably connected to the wing frame at a second pivot axis (such as pivot axis 910). At 1302, an actuator (which may be similar to actuator 914) interconnecting the center frame of the agricultural head and the wing frame of the head is extended a first amount. In response, the wing frame is moved, such as via rotation about the second pivot axis, from a folded configuration to an unfolded configuration, as indicated at 1304. At 1306, the intermediate portion is released form a fixed location relative to the center frame. Release of the intermediate portion may occur at the conclusion of extension of the actuator by the first amount or at some time prior to the actuator extending the first amount. At 1308, the intermediate portion pivots about the first pivot axis relative to the center frame. At 1310, the actuator is further extended a second amount, beyond the first amount, to move the wing frame through an articulation range. In some implementations, movement of the wing frame in response to extension of the actuator by the second amount involves rotation of the wing frame about a second pivot axis. In some instances, the wing frame is rotated about the second pivot axis along an angular range (corresponding to the articulation range) in response to extension of the actuator by the second amount. The actuator may be extended or retracted to cause the wing frame to be lowered or raised, respectively, as the wing is rotated within the angular range.

Various features of method 1300 may be rearranged, added, or removed and still be within the scope of the present disclosure. For example, the method 1300 may include locking the intermediate portion the fixed location relative to the center frame. Additionally, the method 1300 may include retracting the actuator to move the wing frame to the unfolded configuration and further retracting the actuator to move the wing frame from the unfolded configuration to the folded configuration.

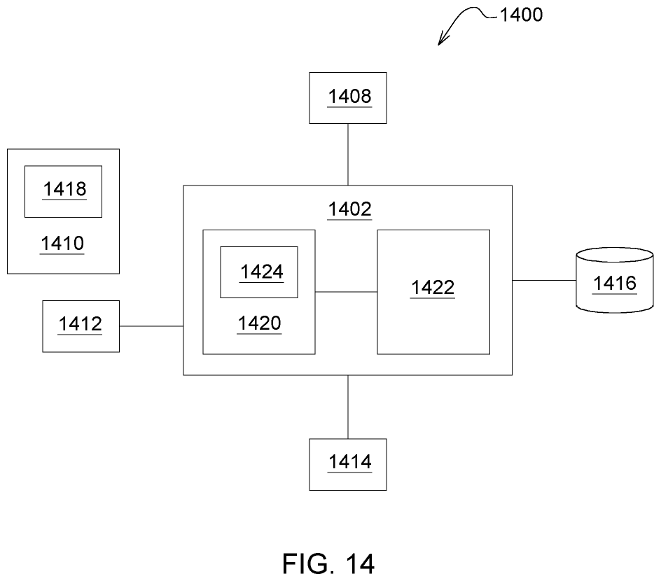

FIG. 14 is a schematic view of a control system 1400 for controlling operation of the head, particularly operation of the movement of a wing frame (such as wing frame 204 and 904) relative to a center frame (such as center frame 202 and 902), as described herein. The control system 1400 includes an electronic controller 1402, at least one sensor 1408, a display 1410, an input device 1412, and an actuator 1414 that is controllable in response to sensed input from the at least one sensor 1408. The control system 1400 may also include or be communicably coupled to a remote database 1416, which may be in the form of cloud storage, a remote server, or some other type of electronic storage configured to store information. The various components of the control system 1400 are communicably coupled to the controller 1402, such as via a wired or wireless connection. Example sensors include an angular position sensor or any type of sensor to detect an amount of movement (e.g., rotational movement) of a wing frame of an agricultural head relative to a center frame of the agricultural head. Example sensors also include sensors operable to detect an amount of extension or retraction of the actuator (such as an amount of linear extension and retraction).

In some implementations, the controller 1402 is a computer system, such as computer system 1500 described in more detail below. The controller 1402 includes a processor 1420 communicably coupled to a memory 1422. Additional details of the controller 1402, such as processor 1420 and memory 1422, are described below in the context of computer system 500. The memory 1422 communicates with the processor 1420 and is used to store programs and other software, information, and data. The processor 1420 is operable to execute programs and software and receive information from and send information to the memory 1422. Although a single memory 1422 and a single processor 1420 are illustrated, in other implementations, a plurality of memories, processors, or both may be used. Although the processor 1420 and the memory 1422 are shown as being local components of the controller 1402, in other implementations, one or both of the processor 1420 and memory 1422 may be located remotely. Software 1424, such as in the form of an application or program, is executed by the processor 1420 to control operation of the control system 1400, as described herein. Particularly, the software 1424 includes executable instructions operable to control operation of the actuator, for example, based on input received from the one or more sensors 1408.

The input device 1412 is communicably coupled via a wired or wireless connection. Example input devices 1412 include a keyboard, keypad, one or more buttons, a slider bar, a dial, a knob, a mouse, or a joystick. The display 1410 is communicably coupled to the controller 1402 via a wired or wireless connection. The display 1410 displays information, such as information related to the operation of control system 1400. For example, information displayed by the display 1410 may include an angular position of a wing frame relative to a center frame of an agriculture head, an amount of actuator of the actuator 1414, and a position of an intermediate portion of the agriculture head relative to another portion of the agriculture head, such as the center frame. In some instances, the information displayed by the display 1410 is displayed via a graphical user interface (GUI) 1418. Example displays include cathode ray tubes (CRT), liquid crystal displays (LCDs), or plasma displays. Other types of displays are also within the scope of the present disclosure. In some implementations, the display 1410 is a touch screen that is operable to receive input from a user via a user's touch. In some implementations in which the display 1410 is a touch screen, the input device 1412 is omitted.

Without in any way limiting the scope, interpretation, or application of the claims appearing below, a technical effect of one or more of the example implementations disclosed herein is to control folding and unfolding of a wing frame relative to a center frame of an agricultural header as well as articulation of the wing frame in the unfolded configuration with the use of a single actuator. Another technical effect of one or more of the example implementations disclosed herein is to reduce costs and complexity associated with such an agricultural head, for example, as a result of a reduced number of components of the agricultural head.

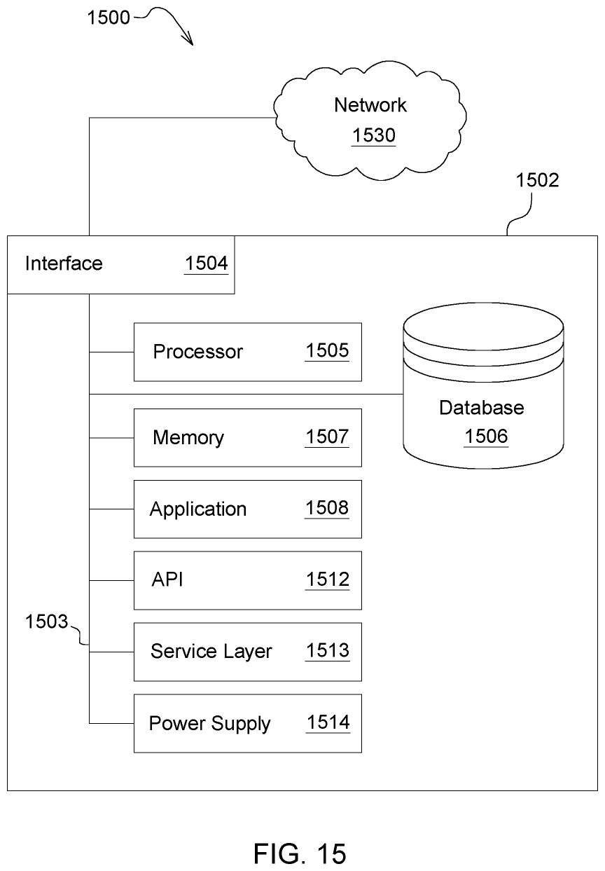

FIG. 15 is a block diagram of an example computer system 1500 used to provide computational functionalities associated with described algorithms, methods, functions, processes, flows, and procedures described in the present disclosure, according to some implementations of the present disclosure. The illustrated computer 1502 is intended to encompass any computing device such as a server, a desktop computer, a laptop/notebook computer, a wireless data port, a smart phone, a personal data assistant (PDA), a tablet computing device, or one or more processors within these devices, including physical instances, virtual instances, or both. The computer 1502 can include input devices such as keypads, keyboards, and touch screens that can accept user information. Also, the computer 1502 can include output devices that can convey information associated with the operation of the computer 1502. The information can include digital data, visual data, audio information, or a combination of information. The information can be presented in a graphical user interface (UI) (or GUI).

The computer 1502 can serve in a role as a client, a network component, a server, a database, a persistency, or components of a computer system for performing the subject matter described in the present disclosure. The illustrated computer 1502 is communicably coupled with a network 1530. In some implementations, one or more components of the computer 1502 can be configured to operate within different environments, including cloud-computing-based environments, local environments, global environments, and combinations of environments.

At a high level, the computer 1502 is an electronic computing device operable to receive, transmit, process, store, and manage data and information associated with the described subject matter. According to some implementations, the computer 1502 can also include, or be communicably coupled with, an application server, an email server, a web server, a caching server, a streaming data server, or a combination of servers.

The computer 1502 can receive requests over network 1530 from a client application (for example, executing on another computer 1502). The computer 1502 can respond to the received requests by processing the received requests using software applications. Requests can also be sent to the computer 1502 from internal users (for example, from a command console), external (or third) parties, automated applications, entities, individuals, systems, and computers.

Each of the components of the computer 1502 can communicate using a system bus 1503. In some implementations, any or all of the components of the computer 1502, including hardware or software components, can interface with each other or the interface 1504 (or a combination of both), over the system bus 1503. Interfaces can use an application programming interface (API) 1512, a service layer 1513, or a combination of the API 1512 and service layer 1513. The API 1512 can include specifications for routines, data structures, and object classes. The API 1512 can be either computer-language independent or dependent. The API 1512 can refer to a complete interface, a single function, or a set of APIs.

The service layer 1513 can provide software services to the computer 1502 and other components (whether illustrated or not) that are communicably coupled to the computer 1502. The functionality of the computer 1502 can be accessible for all service consumers using this service layer. Software services, such as those provided by the service layer 1513, can provide reusable, defined functionalities through a defined interface. For example, the interface can be software written in JAVA, C++, or a language providing data in extensible markup language (XML) format. While illustrated as an integrated component of the computer 1502, in alternative implementations, the API 1512 or the service layer 1513 can be stand-alone components in relation to other components of the computer 1502 and other components communicably coupled to the computer 1502. Moreover, any or all parts of the API 1512 or the service layer 1513 can be implemented as child or sub-modules of another software module, enterprise application, or hardware module without departing from the scope of the present disclosure.

The computer 1502 includes an interface 1504. Although illustrated as a single interface 1504 in FIG. 15, two or more interfaces 1504 can be used according to particular needs, desires, or particular implementations of the computer 1502 and the described functionality. The interface 1504 can be used by the computer 1502 for communicating with other systems that are connected to the network 1530 (whether illustrated or not) in a distributed environment. Generally, the interface 1504 can include, or be implemented using, logic encoded in software or hardware (or a combination of software and hardware) operable to communicate with the network 1530. More specifically, the interface 1504 can include software supporting one or more communication protocols associated with communications. As such, the network 1530 or the interface's hardware can be operable to communicate physical signals within and outside of the illustrated computer 1502.

The computer 1502 includes a processor 1505. Although illustrated as a single processor 1505 in FIG. 15, two or more processors 1505 can be used according to particular needs, desires, or particular implementations of the computer 1502 and the described functionality. Generally, the processor 1505 can execute instructions and can manipulate data to perform the operations of the computer 1502, including operations using algorithms, methods, functions, processes, flows, and procedures as described in the present disclosure.

The computer 1502 also includes a database 1506 that can hold data for the computer 1502 and other components connected to the network 1530 (whether illustrated or not). For example, database 1506 can be an in-memory, conventional, or a database storing data consistent with the present disclosure. In some implementations, database 1506 can be a combination of two or more different database types (for example, hybrid in-memory and conventional databases) according to particular needs, desires, or particular implementations of the computer 1502 and the described functionality. Although illustrated as a single database 1506 in FIG. 15, two or more databases (of the same, different, or combination of types) can be used according to particular needs, desires, or particular implementations of the computer 1502 and the described functionality. While database 1506 is illustrated as an internal component of the computer 1502, in alternative implementations, database 1506 can be external to the computer 1502.

The computer 1502 also includes a memory 1507 that can hold data for the computer 1502 or a combination of components connected to the network 1530 (whether illustrated or not). Memory 1507 can store any data consistent with the present disclosure. In some implementations, memory 1507 can be a combination of two or more different types of memory (for example, a combination of semiconductor and magnetic storage) according to particular needs, desires, or particular implementations of the computer 1502 and the described functionality. Although illustrated as a single memory 1507 in FIG. 15, two or more memories 1507 (of the same, different, or combination of types) can be used according to particular needs, desires, or particular implementations of the computer 1502 and the described functionality. While memory 1507 is illustrated as an internal component of the computer 1502, in alternative implementations, memory 1507 can be external to the computer 1502.

The application 1508 can be an algorithmic software engine providing functionality according to particular needs, desires, or particular implementations of the computer 1502 and the described functionality. For example, application 1508 can serve as one or more components, modules, or applications. Further, although illustrated as a single application 1508, the application 1508 can be implemented as multiple applications 1508 on the computer 1502. In addition, although illustrated as internal to the computer 1502, in alternative implementations, the application 1508 can be external to the computer 1502.

The computer 1502 can also include a power supply 1514. The power supply 1514 can include a rechargeable or non-rechargeable battery that can be configured to be either user- or non-user-replaceable. In some implementations, the power supply 1514 can include power-conversion and management circuits, including recharging, standby, and power management functionalities. In some implementations, the power-supply 1514 can include a power plug to allow the computer 1502 to be plugged into a wall socket or a power source to, for example, power the computer 1502 or recharge a rechargeable battery.

There can be any number of computers 1502 associated with, or external to, a computer system containing computer 1502, with each computer 1502 communicating over network 1530. Further, the terms “client,” “user,” and other appropriate terminology can be used interchangeably, as appropriate, without departing from the scope of the present disclosure. Moreover, the present disclosure contemplates that many users can use one computer 1502 and one user can use multiple computers 1502.

Implementations of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Software implementations of the described subject matter can be implemented as one or more computer programs. Each computer program can include one or more modules of computer program instructions encoded on a tangible, non-transitory, computer-readable computer-storage medium for execution by, or to control the operation of, data processing apparatus. Alternatively, or additionally, the program instructions can be encoded in/on an artificially generated propagated signal. The example, the signal can be a machine-generated electrical, optical, or electromagnetic signal that is generated to encode information for transmission to suitable receiver apparatus for execution by a data processing apparatus. The computer-storage medium can be a machine-readable storage device, a machine-readable storage substrate, a random or serial access memory device, or a combination of computer-storage mediums.

The terms “data processing apparatus,” “computer,” and “electronic computer device” (or equivalent as understood by one of ordinary skill in the art) refer to data processing hardware. For example, a data processing apparatus can encompass all kinds of apparatus, devices, and machines for processing data, including by way of example, a programmable processor, a computer, or multiple processors or computers. The apparatus can also include special purpose logic circuitry including, for example, a central processing unit (CPU), a field programmable gate array (FPGA), or an application-specific integrated circuit (ASIC). In some implementations, the data processing apparatus or special purpose logic circuitry (or a combination of the data processing apparatus or special purpose logic circuitry) can be hardware- or software-based (or a combination of both hardware- and software-based). The apparatus can optionally include code that creates an execution environment for computer programs, for example, code that constitutes processor firmware, a protocol stack, a database management system, an operating system, or a combination of execution environments. The present disclosure contemplates the use of data processing apparatuses with or without conventional operating systems, for example, LINUX, UNIX, WINDOWS, MAC OS, ANDROID, or IOS.

A computer program, which can also be referred to or described as a program, software, a software application, a module, a software module, a script, or code, can be written in any form of programming language. Programming languages can include, for example, compiled languages, interpreted languages, declarative languages, or procedural languages. Programs can be deployed in any form, including as stand-alone programs, modules, components, subroutines, or units for use in a computing environment. A computer program can, but need not, correspond to a file in a file system. A program can be stored in a portion of a file that holds other programs or data, for example, one or more scripts stored in a markup language document, in a single file dedicated to the program in question, or in multiple coordinated files storing one or more modules, sub-programs, or portions of code. A computer program can be deployed for execution on one computer or on multiple computers that are located, for example, at one site or distributed across multiple sites that are interconnected by a communication network. While portions of the programs illustrated in the various figures may be shown as individual modules that implement the various features and functionality through various objects, methods, or processes, the programs can instead include a number of sub-modules, third-party services, components, and libraries. Conversely, the features and functionality of various components can be combined into single components as appropriate. Thresholds used to make computational determinations can be statically, dynamically, or both statically and dynamically determined.

The methods, processes, or logic flows described in this specification can be performed by one or more programmable computers executing one or more computer programs to perform functions by operating on input data and generating output. The methods, processes, or logic flows can also be performed by, and apparatus can also be implemented as, special purpose logic circuitry, for example, a CPU, an FPGA, or an ASIC.

Computers suitable for the execution of a computer program can be based on one or more of general and special purpose microprocessors and other kinds of CPUs. The elements of a computer are a CPU for performing or executing instructions and one or more memory devices for storing instructions and data. Generally, a CPU can receive instructions and data from (and write data to) a memory. A computer can also include, or be operatively coupled to, one or more mass storage devices for storing data. In some implementations, a computer can receive data from, and transfer data to, the mass storage devices including, for example, magnetic, magneto-optical disks, or optical disks. Moreover, a computer can be embedded in another device, for example, a mobile telephone, a personal digital assistant (PDA), a mobile audio or video player, a game console, a global positioning system (GPS) receiver, or a portable storage device such as a universal serial bus (USB) flash drive.

Computer-readable media (transitory or non-transitory, as appropriate) suitable for storing computer program instructions and data can include all forms of permanent/non-permanent and volatile/non-volatile memory, media, and memory devices. Computer-readable media can include, for example, semiconductor memory devices such as random access memory (RAM), read-only memory (ROM), phase change memory (PRAM), static random access memory (SRAM), dynamic random access memory (DRAM), erasable programmable read-only memory (EPROM), electrically erasable programmable read-only memory (EEPROM), and flash memory devices. Computer-readable media can also include, for example, magnetic devices such as tape, cartridges, cassettes, and internal/removable disks. Computer-readable media can also include magneto-optical disks and optical memory devices and technologies including, for example, digital video disc (DVD), CD-ROM, DVD+/-R, DVD-RAM, DVD-ROM, HD-DVD, and BLURAY.

The memory can store various objects or data, including caches, classes, frameworks, applications, modules, backup data, jobs, web pages, web page templates, data structures, database tables, repositories, and dynamic information. Types of objects and data stored in memory can include parameters, variables, algorithms, instructions, rules, constraints, and references. Additionally, the memory can include logs, policies, security or access data, and reporting files. The processor and the memory can be supplemented by, or incorporated in, special purpose logic circuitry.

Implementations of the subject matter described in the present disclosure can be implemented on a computer having a display device for providing interaction with a user, including displaying information to (and receiving input from) the user. Types of display devices can include, for example, a cathode ray tube (CRT), a liquid crystal display (LCD), a light-emitting diode (LED), and a plasma monitor. Display devices can include a keyboard and pointing devices including, for example, a mouse, a trackball, or a trackpad. User input can also be provided to the computer through the use of a touchscreen, such as a tablet computer surface with pressure sensitivity or a multi-touch screen using capacitive or electric sensing. Other kinds of devices can be used to provide for interaction with a user, including to receive user feedback including, for example, sensory feedback including visual feedback, auditory feedback, or tactile feedback. Input from the user can be received in the form of acoustic, speech, or tactile input. In addition, a computer can interact with a user by sending documents to, and receiving documents from, a device that is used by the user. For example, the computer can send web pages to a web browser on a user's client device in response to requests received from the web browser.

The term “graphical user interface,” or “GUI,” can be used in the singular or the plural to describe one or more graphical user interfaces and each of the displays of a particular graphical user interface. Therefore, a GUI can represent any graphical user interface, including, but not limited to, a web browser, a touch screen, or a command line interface (CLI) that processes information and efficiently presents the information results to the user. In general, a GUI can include a plurality of user interface (UI) elements, some or all associated with a web browser, such as interactive fields, pull-down lists, and buttons. These and other UI elements can be related to or represent the functions of the web browser.

Implementations of the subject matter described in this specification can be implemented in a computing system that includes a back-end component, for example, as a data server, or that includes a middleware component, for example, an application server. Moreover, the computing system can include a front-end component, for example, a client computer having one or both of a graphical user interface or a Web browser through which a user can interact with the computer. The components of the system can be interconnected by any form or medium of wireline or wireless digital data communication (or a combination of data communication) in a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN) (for example, using 802.11 a/b/g/n or 802.20 or a combination of protocols), all or a portion of the Internet, or any other communication system or systems at one or more locations (or a combination of communication networks). The network can communicate with, for example, Internet Protocol (IP) packets, frame relay frames, asynchronous transfer mode (ATM) cells, voice, video, data, or a combination of communication types between network addresses.

Wireless connections within the scope of the present disclosure include wireless protocols, such as, 802.15 protocols (e.g., a BLUETOOTH®), 802.11 protocols, 802.20 protocols (e.g., WI-FI®), or a combination of different wireless protocols.

The computing system can include clients and servers. A client and server can generally be remote from each other and can typically interact through a communication network. The relationship of client and server can arise by virtue of computer programs running on the respective computers and having a client-server relationship.

Cluster file systems can be any file system type accessible from multiple servers for read and update. Locking or consistency tracking may not be necessary since the locking of exchange file system can be done at application layer. Furthermore, Unicode data files can be different from non-Unicode data files.

While this specification contains many specific implementation details, these should not be construed as limitations on the scope of what may be claimed, but rather as descriptions of features that may be specific to particular implementations. Certain features that are described in this specification in the context of separate implementations can also be implemented, in combination, in a single implementation. Conversely, various features that are described in the context of a single implementation can also be implemented in multiple implementations, separately, or in any suitable sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results. In certain circumstances, multitasking or parallel processing (or a combination of multitasking and parallel processing) may be advantageous and performed as deemed appropriate.

Moreover, the separation or integration of various system modules and components in the previously described implementations should not be understood as requiring such separation or integration in all implementations, and it should be understood that the described program components and systems can generally be integrated together in a single software product or packaged into multiple software products.

Accordingly, the previously described example implementations do not define or constrain the present disclosure. Other changes, substitutions, and alterations are also possible without departing from the spirit and scope of the present disclosure.

Furthermore, any claimed implementation is considered to be applicable to at least a computer-implemented method; a non-transitory, computer-readable medium storing computer-readable instructions to perform the computer-implemented method; and a computer system comprising a computer memory interoperably coupled with a hardware processor configured to perform the computer-implemented method or the instructions stored on the non-transitory, computer-readable medium.

While the above describes example implementations of the present disclosure, these descriptions should not be viewed in a limiting sense. Rather, other variations and modifications may be made without departing from the scope and spirit of the present disclosure as defined in the appended claims.

What is claimed is:

1. An agricultural head comprising:
a center frame;
a wing frame coupled to the center; and
an intermediate portion disposed between the center frame and the wing frame, the intermediate portion pivotably connected to the center frame at a first pivot axis and pivotably connected to the wing frame at a second pivot axis, the first pivot axis offset from the second pivot axis.

2. The agricultural head of claim 1, wherein a vertical component of the first location is less than a vertical component of the second location.

3. The agricultural head of claim 1, further comprising an actuator interconnecting the center frame and the wing frame, the actuator configured both to rotate the wing frame relative to the center frame about the second pivot axis a first rotational amount between a folded configuration and an unfolded configuration and to articulate the wing frame a second rotational amount beyond the first rotational amount relative to the center frame about the first pivot axis between the unfolded configuration and a fully articulated configuration.

4. The agricultural head of claim 3, wherein the wing frame is pivotable about the first pivot axis, in response to actuation of the actuator, between the unfolded configuration and the fully articulated configuration.

5. The agricultural head of claim 3, further comprising:
a first pivot shaft that defines the first pivot axis; and
a second pivot shaft that defines the second pivot axis,
wherein the second pivot shaft is fixed relative to the center frame when the wing frame is pivoted at least partially between the folded configuration and unfolded configuration and wherein the second pivot shaft is movable relative to the center frame when the wing frame is pivoted between the unfolded configuration and the fully articulated configuration.

6. The agricultural head of claim 3, further comprising a linkage including:
a first link pivotably attached to the center frame; and
a second link pivotably attached to the wing frame, the first link and the second link pivotably attached to each other, and
wherein the actuator is pivotably attached to the center frame at a first end and pivotably connected to the linkage at a location where the first link and the second link are pivotably attached to each other.

7. The agricultural head of claim 1, further comprising an actuator, interconnecting the center frame and the wing frame, configured to pivot the wing frame relative to the center frame about one of the first pivot axis and the second pivot axis.

8. The agricultural head of claim 7, wherein the actuator is a linear actuator.

9. The agricultural head of claim 8, wherein the linear actuator is a hydraulic linear actuator.

10. A method for operating an agricultural head moveable between a folded configuration and an unfolded configuration and articulatable in the unfolded configuration, the method comprising:
actuating an actuator interconnecting a wing frame of the agricultural head and a center frame of the agricultural head by a first amount in a first direction to unfold the wing frame from a folded configuration to an unfolded configuration;
pivoting the wing frame about a first pivot axis pivotably connecting an intermediate portion and the wing frame at a first location along the intermediate portion in a first rotational direction in response to actuating the actuator in the first direction to unfold the wing frame;
actuating the actuator in the first direction by a second amount beyond the first amount; and
pivoting the wing frame about a second pivot axis pivotably connecting the intermediate portion and the center frame at a second location along the intermediate portion offset from the first location in the first rotational direction in response to articulation of the actuator in the first direction by the second amount.

11. The method of claim 10, wherein pivoting the wing frame about the second pivot axis in response to articulation of the actuator by the second amount includes pivoting the wing frame between the unfolded configuration and a fully articulated configuration.

12. The method of claim 10, wherein pivoting the wing frame about a first pivot axis pivotably connecting a first end of an intermediate portion and the wing frame in a first rotational direction in response to actuating the actuator in the first direction to unfold the wing frame includes pivoting the wing frame about the first pivot axis a first rotational amount in the first rotational direction.

13. The method of claim 10, further comprising fixing a location of the first pivot axis relative to the center frame such that the intermediate portion is prevented from rotating relative to the center frame about the second pivot axis when the when the wing frame is pivoted about the first pivot axis in the first rotational direction in response to actuation of the actuator in the first direction.

14. The method of claim 13, wherein pivoting the wing frame about a second pivot axis pivotably connecting a second end of the intermediate portion, opposite the first end, and the center frame in the first rotational direction in response to articulation of the actuator in the first direction by the second amount includes releasing the first pivot axis relative to the center frame to cause the intermediate portion to pivot about the second pivot axis relative to the center frame.

15. The method of claim 10, further comprising pivoting the first wing frame about the second pivot axis by a first rotational amount between the fully articulated configuration and the unfolded configuration in response to actuation of the actuator by a first amount in a second direction, opposite the first direction.

16. An agricultural system comprising:
an agricultural machine configured to move along a surface;
an agricultural head connected to the agricultural machine and configured to harvest crop as the agricultural head is moved along the surface by the agricultural machine, the agricultural head comprising:
a center frame;
a wing frame coupled to and disposed laterally adjacent to the center; and
an intermediate portion disposed between the center frame and the wing frame, the intermediate portion pivotably connected to the center frame at a first rotational axis and pivotably connected to the wing frame at a second rotational axis, the first rotational axis positioned at a first location on the center frame and the second rotational axis positioned at a second location along the wing frame, the first location offset from the second location.

17. The agricultural system of claim 16, wherein a vertical component of the first location is less than a vertical component of the second location.

18. The agricultural system of claim 1, wherein the agricultural header further comprises an actuator interconnecting the center frame and the wing frame, the actuator configured both to rotate the wing frame relative to the center frame about the second pivot axis a first rotational amount between a folded configuration and an unfolded configuration and to articulate the wing frame a second rotational amount beyond the first rotational amount relative to the center frame about the first pivot axis between the unfolded configuration and a fully articulated configuration.

19. The agricultural system of claim 18, wherein the second pivot axis is fixed relative to the center frame when the wing frame is pivoted at least partially between the folded configuration and unfolded configuration and wherein the second pivot axis is movable relative to the center frame when the wing frame is pivoted between the unfolded configuration and the fully articulated configuration.

20. The agricultural system of claim 18, wherein the agricultural head comprises a linkage including:
a first link pivotably attached to the center frame;
a second link pivotably attached to the wing frame, the first link and the second link pivotably attached to each other, and
wherein the actuator is pivotably attached to the center frame at a first end and pivotably connected to the linkage at a location where the first link and the second link are pivotably attached to each other.
